(19) United States
(12) Patent Application Publication
(10) Pub. No.: US 2006/0132444 A1
(43) Pub. Date: Jun. 22, 2006

(54) Glove input device

(76) Inventors: Li-Shen Juhn, Longtan Township (TW); Wen-Chyie Yen, Longtan Township (TW); Yin-Kuan Lin, Longtan Township (TW)

Correspondence Address: RABIN & BERDO, P.C.;Suite 500, 1101 14 Street, N.W., Washington, DC, 20005, US

(21) Appl. No.: 10/916,531

(22) Filed: Aug. 12, 2004

(51) Int. Cl. G09G 5/00

(52) U.S. Cl. 345/168

(57) ABSTRACT

A glove input device with two gloves and an encoder is described. Each glove has several finger parts for the insertion of fingers. The front and back of the finger part have several contact points. The contact points on the thumb are defined as the first set of contact points, those of the rest finger parts the second set of contact points. When any of the first set of contact points is in touch with any of the second set of contact points, a current loop is formed to generate a current signal. The encoder receives the current signal and outputs a corresponding character code signal of the contact points in touch.

### BACKGROUND OF THE INVENTION

1. Field of Invention

The invention relates to an input device and, in particular, to a glove input device that uses contact points on fingers to generate a contact signal and thus a corresponding character code.

2. Related Art

With a rapid development in information processing systems, there are more and more powerful functions available to users. In order to use various complicated functions, it is necessary to employ a complicated set of commands and a lot of information for inputs. Therefore, the input device is an important component of information processing systems.

A basic circuit of the conventional matrix keyboard is shown in FIG. 1. The encoder 10 is a matrix encoder. After receiving a current signal from the keyboard, it outputs a corresponding character code to the computer 20. The encoder 10 has several X contact points (X1, X2, . . . ) and several Y contact points (Y1, Y2, . . . ). The X and Y contact points constitute a matrix circuit structure. Each cross point corresponds to a button. For example, each X contact point, such as X1, has one or many contactable points (X1,1, X1,2). Each Y contact point, such as Y2, also has one or many contactable points (Y2,1, Y2,2). Each text symbol has a corresponding “button.” Pressing the button will form a closed loop between an X contact point and a Y contact point. The encoder 10 then generates a corresponding symbol code to the computer 20. Therefore, even though both button A and button B use the X1 contact point, one has to operate two different contactable points (X1,1, X1,2). Moreover, the buttons cannot be too small for the user to operate.

During the evolution of portable computers, the primary part can be minimized and the screen can be made into a glass. However, the size of the keyboard cannot be reduced due to the limitation of finger operations and the number of characters. Therefore, the traditional keyboard is an obstacle to the miniaturization of portable information devices or palm-size information processing devices.

Although the modern semiconductor technology has no problem in minimizing circuits, human palms cannot be made smaller. Thus, the keyboard has to be larger enough for fingers to operate. It is thus imperative to develop a new type of input device that can be made compact.

### SUMMARY OF THE INVENTION

In view of the foregoing, an objective of the invention is to provide a glove input device.

To achieve the above objective, the disclosed glove input device contains at least one glove and an encoder. Each glove has several finger parts for the insertion of fingers. The front and back of each finger part have several contact points. The contact points on the thumb part are defined as the first set of contact points and those of the rest finger parts as the second set of contact points. When any of the first set of contact points is in touch with any of the second set of contact points, a current loop is formed to generate a current signal. The encoder receives the current signal and outputs a corresponding character code signal according to the contact points in touch.

According to the objective and principle of the invention, the disclosed glove input device is put on user's hands. The user snaps one X contactable point and a Y contactable point, forming a current loop between the corresponding X contact point and Y contact point. The encoder generates a corresponding symbol code to the computer, rendering the same result as using a keyboard.

According to the objective and principle of the invention, each contact point of the disclosed glove input device has only one contactable point. Thus, it has a simple circuit layout.

According to the objective and principle of the invention, the disclosed glove input device does not have any button. Therefore, it avoids the problem of being impossible to minimize.

### BRIEF DESCRIPTION OF THE DRAWINGS

The invention will become more fully understood from the detailed description given hereinbelow illustration only, and thus are not limitative of the present invention, and wherein:

FIG. 1 is a circuit diagram of the keyboard in the prior art;

FIG. 2 is a circuit diagram of the disclosed glove input device;

FIG. 3 is a schematic view of the contact points in the disclosed glove input device; and

FIG. 4 is another schematic view of the contact points in the disclosed glove input device.

### DETAILED DESCRIPTION OF THE INVENTION

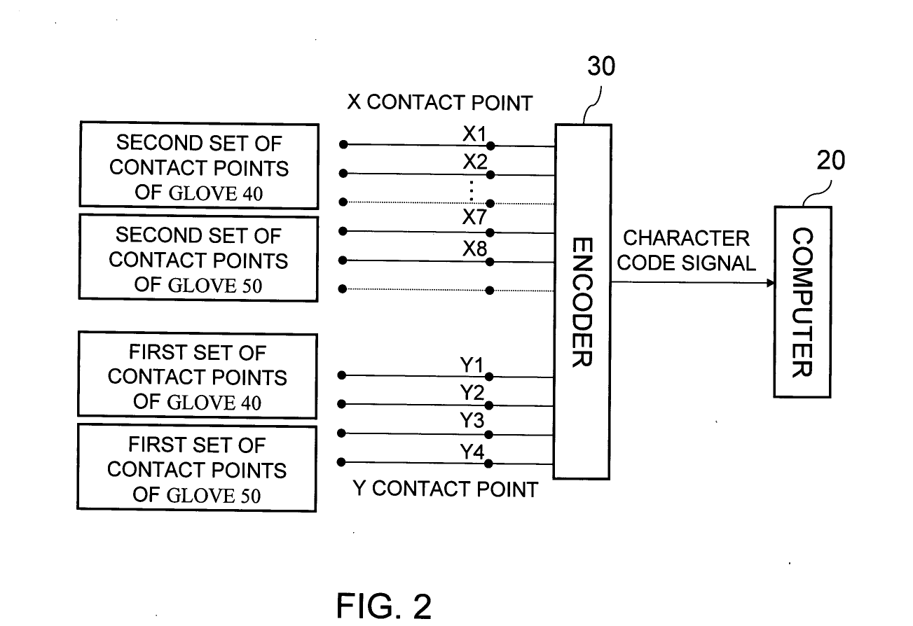

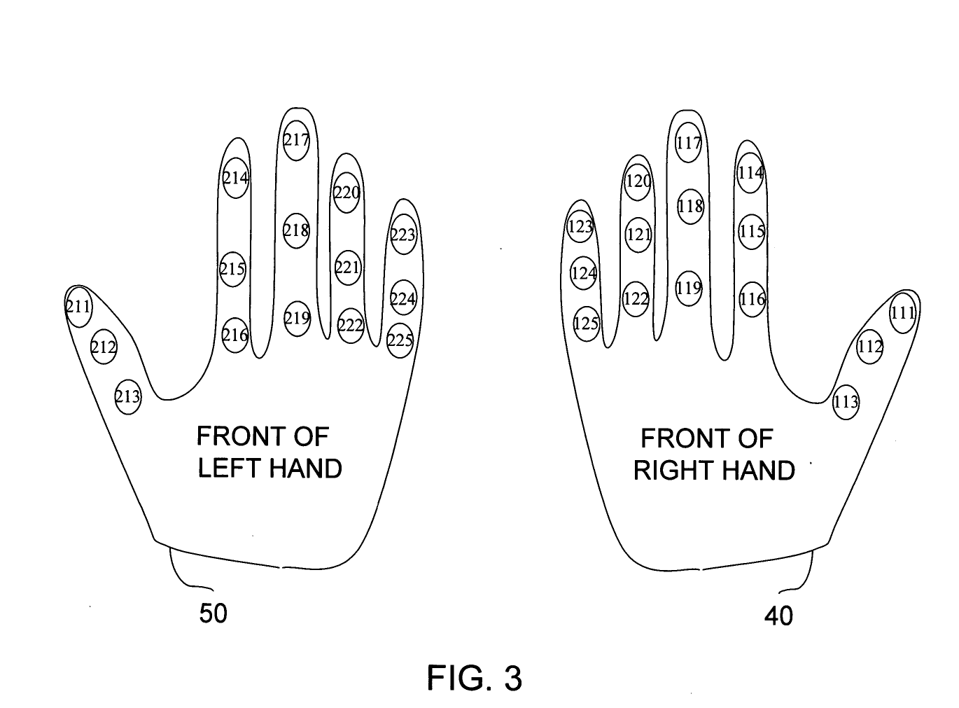

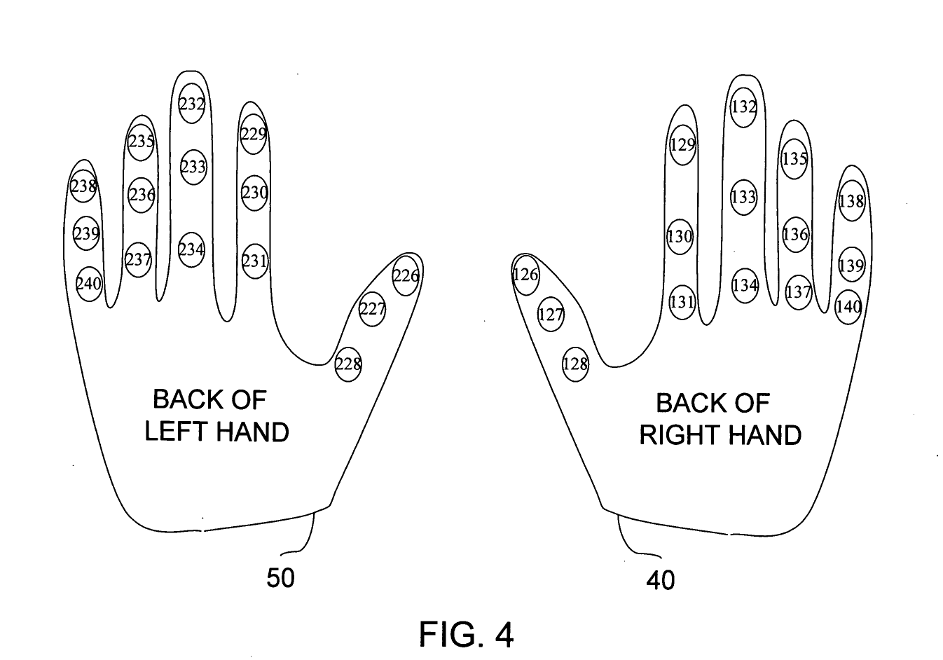

With reference to FIG. 2, the invention is comprised of two gloves 40, 50 (see FIGS. 3 and 4) and an encoder 30. Each of the gloves 40, 50 has several finger parts for the insertion of fingers. The front and back of each finger part have several contact points. The contact points on the thumb part are defined as the first set of contact points (e.g., Y contact points Y1, Y2, . . . , Y7, Y8 . . . ), and those of the rest finger parts as the second set of contact points (e.g., X1, X2, . . . , X7, X8 . . . ). When any of the first set of contact points is in touch with any of the second set of contact points, a current loop is formed to generate a current signal. The encoder 30 receives the current signal and outputs a corresponding character code signal according to the contact points in touch.

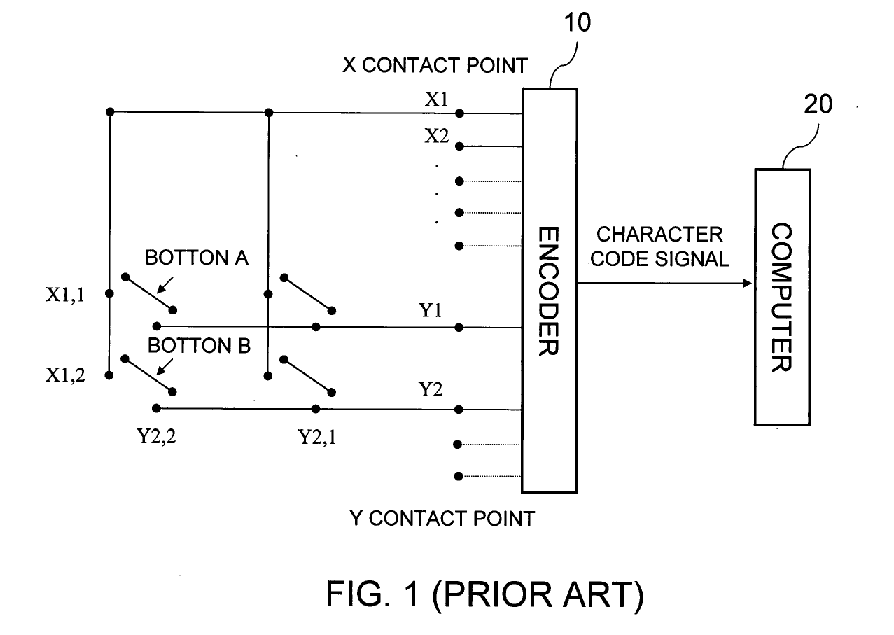

Comparing FIGS. 1 and 2, one finds that the prior art uses button triggering and a matrix circuit to input character codes, while the invention does not adopt button triggering. Instead, the invention uses two contact points at different positions of the (same or different) gloves as the triggering method. The coding after the contact point triggering is done using an encoder 30. For example, the matrix encoder outputs the corresponding character code to the computer 20. The computer described herein generally refers to a desktop computer, personal computer (PC), laptop computer, palm computer, and mobile phone.

We describe in the following an embodiment of the invention. It should be mentioned that the coding method described below is only an example and can be modified according to the user's preferred convention.

Analyses show that the snapping actions of human palms are mostly between the thumb and the other four fingers (forefinger, middle finger, ring finger, little finger). One can use only a single hand to complete 39 snapping actions, corresponding to thirty-nine buttons on the keyboard. Therefore, both hands can form seventy-right combinations to completely replace the current keyboard.

In FIGS. 3 and 4, the front and back surfaces of each finger part on each glove have three contact points. That is, each glove is provided with 30 contact points.

1. The 12 buttons on the right-hand side of the English letter keyboard are obtained by using the first contact point on the front of the right thumb as the Y contact point to touch the contact points on the front surfaces of other fingers of the right hand. For example, touching the first contact point 111 on the front surface of the right thumb upon the first contact points 114, 117, 120, 123 on the front surfaces of the forefinger, middle finger, ring finger, and little finger generates, respectively, the letters P, O, I, and U. Touching the first contact point 111 on the front surface of the right thumb upon the second contact points 115, 118, 121, 124 on the front surfaces of the forefinger, middle finger, ring finger, and little finger generates, respectively, the letters L, K, J, and H. Touching the first contact point 111 on the front surface of the right thumb upon the third contact points 116, 119, 122, 125 on the front surfaces of the forefinger, middle finger, ring finger, and little finger generates, respectively, the letters M, N, B, and V or the characters.

The coding is given by the following table:

| Y contact point | X contact point | En |
|---|---|---|
| Contact point 111 | Contact point 114 | P |
| Contact point 111 | Contact point 117 | O |
| Contact point 111 | Contact point 120 | I |
| Contact point 111 | Contact point 123 | U |
| Contact point 111 | Contact point 115 | L |
| Contact point 111 | Contact point 118 | K |
| Contact point 111 | Contact point 121 | J |
| Contact point 111 | Contact point 124 | H |
| Contact point 111 | Contact point 116 | M |
| Contact point 111 | Contact point 119 | N |
| Contact point 111 | Contact point 122 | B |
| Contact point 111 | Contact point 125 | V |

2. The 12 button on the left-hand side of the English letter keyboard are obtained by using the first contact point on the front of the left thumb as the Y contact point to touch the contact points on the front surfaces of other fingers of the left hand. For example, touching the first contact point 211 on the front surface of the left thumb upon the first contact points 214, 217, 220, 223 on the front surfaces of the forefinger, middle finger, ring finger, and little finger generates, respectively, the letters E, R, T, and Y. Touching the first contact point 211 on the front surface of the left thumb upon the second contact points 215, 218, 221, 224 on the front surfaces of the forefinger, middle finger, ring finger, and little finger generates, respectively, the letters S, D, F, and G. Touching the first contact point 211 on the front surface of the left thumb upon the third contact points 216, 219, 222 on the front surfaces of the forefinger, middle finger, and ring finger generates, respectively, the letters Z, X, and C.

The coding is given by the following table:

| Y Contact point | X Contact point | En |
|---|---|---|
| Contact point 211 | Contact point 214 | E |
| Contact point 211 | Contact point 217 | R |
| Contact point 211 | Contact point 220 | T |
| Contact point 211 | Contact point 223 | Y |
| Contact point 211 | Contact point 215 | S |
| Contact point 211 | Contact point 218 | D |
| Contact point 211 | Contact point 221 | F |
| Contact point 211 | Contact point 224 | G |
| Contact point 211 | Contact point 216 | Z |
| Contact point 211 | Contact point 219 | X |
| Contact point 211 | Contact point 222 | C |
| Contact point 211 | Contact point 225 | |

3. Arabic number buttons are given by using the first contact point on the front surface of the right thumb as the Y contact point to touch the contact points on the back surface of other right fingers. For example, touching the first contact point 111 on the front surface of the right thumb upon the first contact points 129, 132, 135, 138 on the back surfaces of the forefinger, middle finger, ring finger, and little finger generates, respectively, the numbers 1, 2, 3, and 4 or the characters of first, second, third, and fourth tones. Touching the first contact point 111 on the front surface of the right thumb upon the second contact points 130, 133, 136, 139 on the back surfaces of the forefinger, middle finger, ring finger, and little finger generates, respectively, the numbers 5, 6, 7, and 8. Touching the first contact point 111 on the front surface of the right thumb upon the third contact points 131, 134, 137, 140 on the back surfaces of the forefinger, middle finger, ring finger, and little finger generates, respectively, 9, 0, −, and =.

The coding is given by the following table:

| Y contact point | X contact point | En |
|---|---|---|
| Contact point 111 | Contact point 129 | 1! |
| Contact point 111 | Contact point 132 | 2@ |
| Contact point 111 | Contact point 135 | 3# |
| Contact point 111 | Contact point 138 | 4$ |
| Contact point 111 | Contact point 130 | 5% |
| Contact point 111 | Contact point 133 | 6\hat{ } |
| Contact point 111 | Contact point 136 | 7& |
| Contact point 111 | Contact point 139 | 8* |
| Contact point 111 | Contact point 131 | 9( |
| Contact point 111 | Contact point 134 | 0) |
| Contact point 111 | Contact point 137 | -_{—} |
| Contact point 111 | Contact point 140 | =+ |

4. Control buttons are obtained using the contact points 126, 127, 128 as the Y contact point to touch the front surfaces of other right fingers. The coding is given by the following table:

| | | | |
|---|---|---|---|
| Y contact point | X contact point | Zu-In | En |

| | | |
|---|---|---|
| Contact point 126 | Contact point 114 | Enter |
| Contact point 126 | Contact point 117 | Space |
| Contact point 126 | Contact point 120 | Backspace |
| Contact point 126 | Contact point 123 | \\| |
| Contact point 127 | Contact point 114 | Shift |
| Contact point 127 | Contact point 117 | Ctrl |
| Contact point 127 | Contact point 120 | Alt |

| | | |
|---|---|---|
| Contact point 128 | Contact point 114 | Del |

5. Symbol buttons are obtained using the second contact point 112 on the front surface of the right thumb to touch the back surfaces of other right fingers. The coding is given by the following table:

| Y contact point | X contact point | En |
|---|---|---|
| Contact point 112 | Contact point 129 | ,< |
| Contact point 112 | Contact point 130 | .> |
| Contact point 112 | Contact point 131 | /? |
| Contact point 112 | Contact point 132 | ;: |
| Contact point 112 | Contact point 133 | ‘“ |
| Contact point 112 | Contact point 135 | [{ |
| Contact point 112 | Contact point 136 | ]} |
| Contact point 112 | Contact point 138 | |

6. Three other English buttons and cursor control buttons are obtained using the first contact point 211 on the front surface of the left thumb as the Y contact point to touch the back surfaces of other left fingers. Touching the first contact point 211 on the front surface of the left thumb upon the first contact points on the back surfaces of the forefinger, middle finger, ring finger, and little finger generates, respectively, the letters Q, W, +, and −. Touching the first contact point 211 on the front surface of the left thumb upon the second contact points on the back surfaces of the forefinger, middle finger, and ring finger generates, respectively, A, *, and /.

The coding is given by the following table:

| Y contact point | X contact point | En |
|---|---|---|
| Contact point 211 | Contact point 229 | Q |
| Contact point 211 | Contact point 232 | W |
| Contact point 211 | Contact point 235 | + |
| Contact point 211 | Contact point 238 | − |
| Contact point 211 | Contact point 230 | A |
| Contact point 211 | Contact point 233 | * |
| Contact point 211 | Contact point 236 | / |
| Contact point 211 | Contact point 239 | Snap to lock |
| Contact point 211 | Contact point 231 | [symbol] |
| Contact point 211 | Contact point 234 | → |
| Contact point 211 | Contact point 237 | ↑ |
| Contact point 211 | Contact point 240 | ↓ |

7. Left control buttons are obtained using the back surface of the left thumb as the Y contact point to touch the front surfaces of other left fingers. The coding is given by the following table:

| Y contact point | X contact point | En |
|---|---|---|
| Contact point 226 | Contact point 214 | Tab |
| Contact point 226 | Contact point 217 | ‘˜ |
| Contact point 226 | Contact point 220 | Esc |
| Contact point 226 | Contact point 223 | CapsLock |
| Contact point 227 | Contact point 214 | Shift |
| Contact point 227 | Contact point 217 | Ctrl |
| Contact point 227 | Contact point 220 | Alt |
| Contact point 227 | Contact point 223 | |
| Contact point 228 | Contact point 214 | Ins |

8. Other control buttons are obtained using the second contact point 212 on the front surface of the left thumb as the Y contact point to touch the back surfaces of other left fingers. The coding is given by the following table:

| Y contact point | X contact point | En |
|---|---|---|
| Contact point 212 | Contact point 229 | PrintScreen |
| Contact point 212 | Contact point 230 | ScrollLock |
| Contact point 212 | Contact point 231 | PauseBreak |
| Contact point 212 | Contact point 232 | PgUp |
| Contact point 212 | Contact point 233 | PgDn |
| Contact point 212 | Contact point 235 | Home |
| Contact point 212 | Contact point 236 | End |
| Contact point 212 | Contact point 238 | |

According to the above tables, there are totally 10 Y contact points on the left and right thumbs. Other fingers have 48 X contact points. Therefore, the encoder of these finger contact points is a 48×10 XY matrix encoder.

Other undefined contact point combinations can be defined as other functional buttons to increase the value of the glove input device.

Moreover, in the above coding the left and right thumbs are defined to have the Y contact points, whereas those on other four fingers are defined to have the X contact points.

Each contact point in the glove input device has only one contactable point. This can simplify the circuit layout. Since it does not use the button design, there is no problem of making the device size smaller. When using the invention, the user inserts fingers into the gloves. Snapping one X contactable point to touch one Y contactable point forms a current loop between the corresponding X contact point and Y contact point. The encoder thus generates a corresponding symbol to the computer, rendering the same result as a keyboard.

Current technologies have never disclosed a glove input device that uses snapping for inputs. The disclosed glove input device can solve the problem encountered in size reduction of the keyboard. All the buttons on the current keyboard can be generated by the invention. The invention also has the advantage of easier operations.

Certain variations would be apparent to those skilled in the art, which variations are considered within the spirit and scope of the claimed invention.

What is claimed is:

1. A glove input device, comprising:
two gloves, each of which has a plurality of finger parts for finger insertion whose front and back surfaces are provided with a plurality of contact points;
wherein the contact points on the thumb part are defined as a first set of contact points and the contact points on the rest finger parts are defined as a second set of contact points, and a current loop is formed to generate a current signal when any of the first set of contact points is in touch with any of the second set of contact points; and
an encoder, which receives the current signal and outputs a character code signal corresponding to the contact points in touch.

2. The glove input device of claim 1, wherein touching the first contact point on the front surface of the right thumb upon the first contact points on the front surfaces of the forefinger, middle finger, ring finger, and little finger generates, respectively, the letters P, O, I, and U.

3. The glove input device of claim 1, wherein touching the first contact point on the front surface of the right thumb upon the second contact points on the front surfaces of the forefinger, middle finger, ring finger, and little finger generates, respectively, the letters L, K, J, and H.

4. The glove input device of claim 1, wherein touching the first contact point on the front surface of the right thumb upon the third contact points on the front surfaces of the forefinger, middle finger, ring finger, and little finger generates, respectively, the letters M, N, B, and V.

5. The glove input device of claim 1, wherein touching the first contact point on the front surface of the right thumb upon the first contact points on the back surfaces of the forefinger, middle finger, ring finger, and little finger generates, respectively, the numbers 1, 2, 3, and 4.

6. The glove input device of claim 1, wherein touching the first contact point on the front surface of the right thumb upon the second contact points on the back surfaces of the forefinger, middle finger, ring finger, and little finger generates, respectively, the numbers 5, 6, 7, and 8.

7. The glove input device of claim 1, wherein touching the first contact point on the front surface of the right thumb upon the third contact points on the back surfaces of the forefinger, middle finger, ring finger, and little finger generates, respectively, 9, 0, −, and =.

8. The glove input device of claim 1, wherein touching the first contact point on the front surface of the left thumb upon the first contact points on the front surfaces of the forefinger, middle finger, ring finger, and little finger generates, respectively, the letters E, R, T, and Y.

9. The glove input device of claim 1, wherein touching the first contact point on the front surface of the left thumb upon the second contact points on the front surfaces of the forefinger, middle finger, ring finger, and little finger generates, respectively, the letters S, D, F, and G.

10. The glove input device of claim 1, wherein touching the first contact point on the front surface of the left thumb upon the third contact points on the front surfaces of the forefinger, middle finger, and ring finger generates, respectively, the letters Z, X, and C.

11. The glove input device of claim 1, wherein touching the first contact point on the front surface of the left thumb upon the first contact points on the back surfaces of the forefinger, middle finger, ring finger, and little finger generates, respectively, the letters Q, W, +, and −.

12. The glove input device of claim 1, wherein touching the first contact point on the front surface of the left thumb upon the second contact points on the back surfaces of the forefinger, middle finger, and ring finger generates, respectively, A, *, and /.
